(19) United States
(12) Patent Application Publication
(10) Pub. No.: US 2005/0095054 A1
(43) Pub. Date: May 5, 2005

(54) Scented writing instrument

(76) Inventor: Angelo J. Canale, Queensbury, NY (US)

Correspondence Address: ANGELO J. CANALE, 28 Fox Hollow Lane, Queensbury, NY, 12804, US

(21) Appl. No.: 10/699,437

(22) Filed: Oct. 31, 2003

(51) Int. Cl. B43K 29/00

(52) U.S. Cl. 401/195

(57) ABSTRACT

A writing instrument, substantially of plastic, having a scent impregnated substantially throughout the plastic, thereby affording a long-term release of scent.

### FIELD OF THE INVENTION

This invention relates to a device for fragrance dispensing, having the added value of also functioning as a writing instrument, and which, if so desired, can be inexpensively produced.

### BACKGROUND OF THE INVENTION

Writing and drawing instruments are very well known in the art. Perfume dispensing devices are also known in the art. The stationary and fragrances industries worldwide generate billions of dollars in annual sales respectively—even without either industry's introducing significant consumer-product innovations in its own respective field. While some efforts have been undertaken to create “offspring” products formed by a combination of elements from these two industries, the results of such a union of industries has predominantly been limited to scented inks contained within and dispensed by writing instruments. In spite of the relative success achieved by such cross-industry consumer products as scented colored ink pens, markers and coloring sticks, however, it appears that this success has not been sufficient to justify in the minds of industry executives the continual pursuit of significant research & design and overall development of other crossover products. Consequently, scented writing inks are virtually the only commercially visible and successful combination of elements from the fragrance and the stationary industries.

The primary reason that crossover products between these two industries have not been exploited in the marketplace to the full extent possible is as follows: American business development executives today are inexperienced, and therefore lack the capacity to evaluate the sales potential of new products and, accordingly, are very cautious about developing and introducing new products. Few executives with the power to introduce new technologies, moreover, are willing to risk the potential for failure that new product launches present. Product innovations that cross between two industries are, perhaps, the most frightening prospective products to business executives as the market reception of such products most often has no precedent on which future, prospective sales performance may be “projected.” Another reason for industry executives' reluctance to introduce new products is the fact that as the American marketplace has matured; there is less competitive pressure placed on corporate executives since they feel that their relationships with inexperienced market buyers are solid. Since neither buyers for retail stores, nor suppliers to retail stores feel pressure to introduce new products; consequently, few innovations are inspired. This complacency is further fueled by legitimate concerns that new products can lead to new and unanticipated problems which may be the catalyst for lawsuits against those who make and sell new products. Therefore, today there exists a climate in which in the minds of many corporate decision-makers today, the fear of loss is greater than the desire for gain.

The fact is, and history will bear out, that scented inks are not a particularly imaginative innovation. As an established element of an established industry, inks have proven themselves to offer relatively small risks to consumer health, and therefore, concerns by corporate executives and insurance providers regarding potential for consumer abuse or injury is considered to be minimal. Accordingly, the cost of test marketing is also relatively low. This is very advantageous to companies which limit their test marketing and new product introductions because of the high cost today of both test-marketing a product and then actually launching it.

As a result of the apparent market acceptance and profitability of the first scented ink products, a few products based on scented inks have entered the marketplace and represent the essence of cross-industry products between the fragrance and stationary industries. There is a particular need in the flavors and fragrances industry, however, that has never been adequately addressed and this need could be solved by a new and novel cross-industry stationary product such as is disclosed herein by the device of this invention.

Within the fragrance industry there is a need for samplers that can be distributed by sales reps of fragrance producers when the sales reps approach prospective fragrance retailers. This need for samplers is further continued by retailers who wish to promote, and thereby stimulate, sales of a fragrance to retail shoppers, the end-using consumers. Currently, samplers take a variety of forms, but in virtually every form they require activation by the recipient of the fragrance sample. Today, most commonly, samplers now take the popular form of a micro-fragrance encased in tiny “micro-bubbles” whose fragrance contained within is released through scratching, usually with a consumer's fingernail. These are extremely popular as samplers for fashion magazines and direct mail pieces, as they are thin, and don't require liquid which could leak and harm the magazine paper.

After having been activated, these samplers are entirely useless, and are generally not able to be used a second time, since the scent dissipates from the sampler rather quickly. Consequently, the receiver of a sampler may: 1) activate most any traditional form of sampler, 2) take a mere perfunctory whiff, and then, 3) immediately and summarily discard the sampler, soon to forget the aroma of the scent and perhaps even the brand as well. Since any savvy marketer is familiar with the concept of “out of sight, out of mind,” it is evident that this condition is a disadvantageous one.

Thus, there is a very important need for a sampler which does not require any effort on the part of the receiver to activate it, and which will offer scent for a protracted period of time. The tiny, one-time use miniature fragrance sample bottles of fragrance that are given away for free as promotional samples offer scent for a longer time period than micro-fragrance samplers. These, however, are a relatively expensive promotional means, and moreover, are disadvantageous since often even a fraction of an ounce of perfume can be worth scores of retail dollars. Thus, in the minds of some perfume marketers, giving away even a small amount of actual fragrance is akin to “giving away the store.” Many marketers today also feel that the end-using, consuming public holds free products in low-esteem. In light of this marketing philosophy, particularly when coupled with the relatively high cost of production, free, miniature sample bottles of fragrance are becoming a less-than-very attractive means to promote a fragrance. Brand-developers would gladly eliminate this promotional means if a more effective sampler tool were available.

The value of the invention of this disclosure is multiplied as it not only can maintain the dispensing of a scent for a protracted period of time greater than that of traditional samplers, but it can further permit a lengthier promotional period for the brand-name of the scent which remains more constantly visible while the invention of this disclosure is being functionally used. The invention of this disclosure serves a valuable, useful function so that it will be kept by a prospective consumer and not quickly discarded.

The concept of incorporating a scent into a writing instrument, this is to say of impregnating the instrument as a whole, its accompanying parts, or any individual plastic part or piece that could be added to the instrument itself is both new and novel. Moreover, it is entirely unobvious. This position can be supported easily by these facts: FACT 1: The technology that permits the impregnation of a scent entirely throughout a plastic, the material most commonly used in the production of the greatest number of mass-produced writing/drawing instruments, has been disclosed for at least seven years, as of this writing; FACT 2: The need for creating quality fragrance samplers has existed since the inception of the fragrance industry; FACT 3: No product of this nature has ever yet been disclosed even in prototype form, let alone offered for sale or actually sold or distributed as a finished product; FACT 4: The time required to produce a valid prototype for this invention is relatively short, so that it is impossible for any leading company in any field to promote a serious claim that it recognized this need and started prototyping a similar concept long ago, but has been in the design/development/ prototype stages for many years.

Moreover since the writing/drawing instrument industry has profited from the saleablity of scented inks for years, it would stand to reason that it could have relatively easily adapted its consumer product line to include products whose ink-containing cartridges or outer shell bodies were impregnated with scent during the initial molding/extruding/production process for the ink cartridges or shell bodies. This has heretofore never been done. Most major corporations that control significant market share in the fragrance and stationary industries seem to feel that the need to fund and encourage the development of significant numbers of new products is unnecessary. As a result of the positions of their companies as market leaders, many corporate executives appear to feel confident that there is minimal need for continual, major innovation in order to maintain their market leadership positions.

The following are some innovations which, while not particularly pertinent constitute the closest relevant prior art:

U.S. Pat. No. 4,244,525 to Manna discloses an instrument for holding a writing implement having a spray pump so that a liquid scent may be emitted when actuated. The invention of Manna's disclosure is relatively expensive to produce, and is not designed to be disposable. Moreover, in order for scent to be dispensed, it must be actuated. This is to say, it does not automatically provide scent to one who is not familiar with the actuating method. Furthermore, it is possible for the liquid scent to leak from the writing instrument all at once, thereby rendering the effectiveness of the invention quickly useless. Manna's disclosure does not deal with or refer to the concept of combining fragrance and plastic.

U.S. Pat. No. 3,888,416 to Lin discloses an instrument for holding a writing implement having vaporizable material mounted therein. The vaporizable material is located in only in one area of the writing implement, and in a small, concentrated amount. A rotatable cap is disclosed that must be turned, as a means of actuation, in order to permit the vaporizable material to give-off scent. Lin's disclosure does not deal with or refer to the concept of combining fragrance and plastic.

Neither of the afore-mentioned U.S. patents discloses the concept of fragrance-release whereby the fragrance is molded integrally within the body or any part of a writing instrument—nor does any other patent relate the invention of this disclosure.

The fragrance industry that provides scents which can be used for many various applications is an enormous, worldwide and lucrative one. Within this huge industry, however, there are very few scent delivery methods or devices which afford easy and convenient portability while still providing sufficiently effective fragrance potency. There has only-recently been introduced an obviously beneficial scent-delivery method in which a fragrance is contained in a lipstick-type base so that the fragrance is applied like traditional lipstick. However, this method does not embrace the concept of impregnating the plastic lipstick-type HOLDER with a scent. Among the limited selection of fragrance delivery methods, none heretofore has shown itself to be also useful in day-to-day affairs, as well as simple and inexpensive to produce. The invention of this disclosure is useful, inexpensive to produce, and at the same time able to function as an automatic scent dispenser requiring no activation. As easily portable, hand held and palm top computers become more commonplace, it should be noted that there is great potential for inkless “computer-pens” to become commonplace. The application of the invention of this disclosure to inkless computer styluses becomes even more valuable in light of the influence of the technological revolution's on the writing instrument industry, and ever more important as the next stage of evolution for a third, stationary/fragrance crossover products industry. Ink in pens, scented or otherwise, may one day become obsolete.

Recent technological developments currently permit elements of an essential oil to be mixed with common injection-moldable plastic, thereby permitting the molding/extrusion of a resin that is a combination of essential oil—the building block of a fragrance—and plastic. Although prior art discloses some forms of easily portable, relatively small, fragrance-emitting devices, none discloses a device such as a writing or drawing instrument in which an essential oil is integrally combined with the housing body for the ink or other writing element. The invention of this application provides a simple and effective means for dispensing a fragrance into the air over a long period of time; a means that is simply constructed, requires little if any activation on the part of the user, is inexpensive to produce, and is unlikely to be quickly discarded since it affords the user an added functional benefit as a writing instrument; it further functions as a continual advertising promotion of the fragrance trade-name as long as it functions as a writing instrument.

These and other objects and advantages of the invention will become more apparent from the following detailed description and claims.

### SUMMARY AND OBJECTS OF THE INVENTION

The present invention is a device which provides the combination of a novel, a simple and, when required, an inexpensive means for dispensing a fragrance into the air, and which also offers another useful function by serving as a drawing and/or writing tool.

An object of this invention is to provide a fragrance-releasing device for freely dispensing a scented fragrance into the air at a generally constant rate.

Still another object of the present invention to produce a device which can dispense fragrance for a relatively “long” time period, and which does not need to be re-impregnated with scent since it can be manufactured and sold cheaply enough to be considered “disposable.”

Yet still another object of this invention is to provide a scented, fragrance-releasing device which is simple and inexpensive to manufacture, relatively small to transport, simple to use, inexpensive to sell, and/or which may be given away for free as a promotional item.

Still yet another object of this invention is to provide a scented, fragrance-releasing device that may function as a writing instrument of the types that include non-ink-dispensing computer or handheld organizer styluses, common plastic pencils, and common, traditional ink-dispensing pens.

Another object of this invention is to provide a scented fragrance-releasing device which is non-toxic.

Yet another, further object of this invention is to provide a packaging format that includes a vapor-barrier bag that substantially contains a fragrance within the scented, fragrance-releasing device until product use is desired.

### BRIEF DESCRIPTION OF THE DRAWINGS

FIG. 1 is a side view of an elongated tube with a recess to accommodate an ink cartridge and ballpoint system with a cap for the writing system;

FIG. 2 is a tubular system with a cap for the tube, a cap for the writing system and a traditional writing system;

FIG. 3 is a rod-like element and an exterior ink cartridge that gets attached to the rod-like element, and a removable cap;

FIG. 4 is a rod-like element and an exterior ink cartridge that gets attached to the rod-like element and a cap that is attached to the rod via a living hinge;

FIG. 5 is an embodiment in the form of a narrow rectangle with a graphite or ink writing system that can be inserted into it;

FIG. 6 is a top-view of an embodiment of a body suitable for gripping and advertising;

FIG. 7 is a traditional pen embodiment of plastic;

FIG. 8 is a writing stylus in which the tip and body are formed of a unitary member.

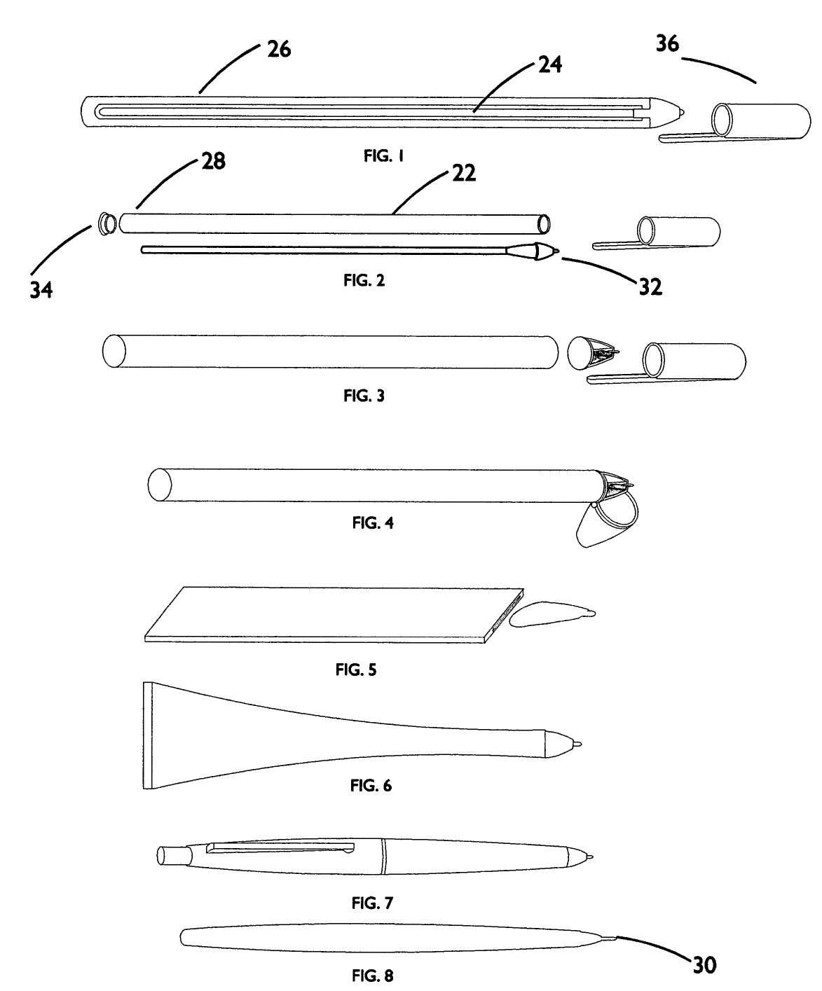

Tube 22

Interior 24

Exterior 26

Cover Cap 36

End 28

Tip 30

Plug 34

Conventional-Ballpoint Ink-Writing-Device 32

### DESCRIPTION OF THE PREFERRED EMBODIMENT

Prior to molding or extruding any shape preferably using traditional, common plastic extrusion or molding machinery, conventional pelletized resin is obtained, preferably polyethylene, or another polymer that will readily accept a fragrance oil for extruding or molding. This resin contains the essence of at least one essential oil. This combination of resin and essential oil requires any molds used in production to be conventionally modified so that conventional vents function to permit the escape of gases formed during production. This information is known to one skilled in the art.

The essential oil-impregnated resin is then fed into the molding/extruding machine. In a preferred embodiment for a writing instrument, an essentially elongated tubular shape is extruded, Tube 22. This elongated tubular shape has Interior 24 and Exterior 26. Exterior 26 has a relatively smooth surface suitable for easy gripping by a user. In a preferred embodiment, interior 24 is smooth having End 28 and Tip 30 suited to be able to accept Conventional Ballpoint Ink Writing Device 32. End 28 is flat and able to accommodate the introduction of Plug 34 which functions to prevent or at least hinder the escape of any ink that may escape Interior 24 of Tube 22. Tip 30 is tapered to a point to better accommodate the introduction of Conventional Ballpoint Ink Writing Device 32 as well as Cover Cap 36.

Cover Cap 36 may also be produced in a similar manner, that is to say, molded using a scented plastic batch. Cover Cap 36 will have one open end removeably engageable, or actually attached to the writing instrument via a living hinge. Traditional cover caps are familiar to those skilled in the art and are acceptable. Cover caps with or without an appendage used for securing a writing instrument to a shirt or suit jacket pocket are acceptable.

The apparent ease of production of the invention of this disclosure does not detract from the new, novel and unobvious combination of the application of a long-term scent-release plastic with a scent-delivery system that functions as a writing instrument.

After the molding/extrusion process is completed, the produced product is overwrapped in a conventional fashion by any traditional vapor-barrier film. With regard to packaging, the finished writing instrument is inserted into a wrapper or bag that has vapor barrier characteristics made of plastic or metallized packaging materials that will contain a fragrance preferably composed of a plastic polymer material such as EVOH™ which is extremely resistant to scent dissipation.

1. For use in freshening air, the scent or fragrance-releasing device comprising:
a plastic body having an outer surface constructed and arranged to be gripped by a user;
said plastic body having a scent source means comprising at least one scent integrally mixed in combination with the plastic of said plastic body;
writing means in contact with said plastic body.

2. The scent or fragrance-releasing device of claim, wherein:
said plastic body is constructed as an elongated body wherein said elongated body has an interior and an exterior and defines an interior chamber, and includes a first end having a bore therethrough and a second end;
said interior is configured to accept a writing means;

3. The scent or fragrance-releasing device of claim 2, wherein:
said writing means is an ink delivery system in the form of traditional combination ink cartridge and ballpoint;

4. The scent or fragrance-releasing device of claim 2, wherein:
said elongated body has an aperture on two ends and wherein said first end of said elongated body is configured to accept a traditional ink delivery system in the form of a combination ink cartridge and ballpoint, and said second end configured to accept a stopper for preventing ink leakage from said elongated body;

5. The scent or fragrance releasing device of claim 4, wherein:
said stopper is constructed of plastic and has a scent source means comprising at least one scent integrally mixed in combination with the plastic of said stopper;

5. The scent or fragrance-releasing device of claim 4, wherein:
said elongated body is configured to accept a cap-like element frictionally engaged with said elongated body for preventing ink leakage from said writing delivery system;

6. The scent or fragrance-releasing device of claim 5, wherein:
said cap-like element is constructed of plastic and has a scent source means comprising at least one scent integrally mixed in combination with the plastic of said cap-like element;

7. The scent or fragrance-releasing device of claim 6, wherein:
said cap-like element is removably mounted on said elongated body;
said ink cartridge is constructed having a plastic body having a scent source means comprising at least one scent integrally mixed in combination with the plastic body of said ink cartridge;

8. The scent or fragrance-releasing device of claim 1, wherein:
said plastic body is constructed as an elongated body wherein said elongated body includes a first end second end;

9. The scent or fragrance-releasing device of claim 8, wherein:
said writing means in contact with said body comprises a combination ink-cartridge and ballpoint system having a pre-determined amount of ink within said ink-cartridge;

10. The scent or fragrance-releasing device of claim 9, wherein:
said means for maintaining said writing means in contact with said body comprises an adhesion action using sonic welding;

11. The scent or fragrance-releasing device of claim 10, wherein:
said writing means in contact with said body comprises a traditional pencil-like writing material;
said means for maintaining said writing means in contact with said body comprises an adhesion action using glue;

12. The scent or fragrance-releasing device of claim 11, wherein:
said means for maintaining said writing means in contact with said body comprises an integral, annular cavity molded into at least one end of said elongated body constructed to accept a writing material or fluid;

13. For use in freshening air, the scent or fragrance releasing device comprising:
an elongated body portion having an outer surface constructed and arranged to be gripped by a user;
a stylus tip;
said stylus tip and said body portion are formed as a unitary member, said unitary member having a scent source means;

14. The scent or fragrance-releasing device of claim 1, including a package system comprising:
a sealable, odor-tight storage bag comprised of a polymer plastic for receiving said Fragrance-releasing device for preventing the substantial dissipation of said scent until use is desired;

15. The package system of claim 14, wherein:
said package system is comprised of a vapor barrier plastic;

16. The scent or fragrance-releasing device of claim 15, wherein:
said package system vapor barrier plastic is EVOH™.

17. The scent or fragrance-releasing device of claim 17, wherein:
said package system has resealable closing means.

18. For use in freshening air, the scent or fragrance releasing device comprising:
an elongated housing of plastic having a size and shape approximate to that of a pen or pencil;
said elongated housing having a closed end and an open end;
said closed end of said elongated housing having an inner recess extending longitudinally into said housing towards said open end;
said recess being shaped to removably receive a writing implement therein;
a liquid holding annular chamber defined between said elongated housing and said inner recess, closed at the closed end of said housing and open at the open end of said housing;
means for permitting liquid contained within said liquid holding annular chamber to exit said annular chamber;
said elongated housing of plastic having a scent source means.

19. For use in freshening air, the scent or fragrance releasing device comprising:
a writing fluid;
housing for a writing fluid wherein said housing is comprised of a scent source means wherein said scent source means comprises an integral combination mixture of at least one scent and a plastic;
a means for uniformly dispensing said writing fluid.
